(19) United States
(12) Patent Application Publication
(10) Pub. No.: US 2015/0158056 A1
(43) Pub. Date: Jun. 11, 2015

(54) LIGHT-ASSISTED ACOUSTIC CLEANING TOOL

(71) Applicant: SEMATECH, Inc., Albany, NY (US)

(72) Inventor: Abbas RASTEGAR, Schenectady, NY (US)

(73) Assignee: SEMATECH, Inc., Albany, NY (US)

(21) Appl. No.: 14/098,713

(22) Filed: Dec. 6, 2013

(51) Int. Cl. B08B 7/02; B08B 7/04; B08B 3/12; B08B 7/00

(52) U.S. Cl. CPC B08B 7/026; B08B 7/0035; B08B 7/04; B08B 3/12

(57) ABSTRACT

A cleaning tool facilitating removal of particles from a surface is provided which includes an acoustic wave generator and one or more light-emitting diodes. The acoustic wave generator, which is configured to direct acoustic waves towards the surface to be cleaned, may include an acoustic transducer that facilitates generating the acoustic waves, and an acoustic coupler substrate through which the acoustic waves propagate. The light-emitting diode(s), which is configured to direct light towards the surface to be cleaned, is coupled to the acoustic coupler substrate of the acoustic wave generator. The acoustic wave generator and the light-emitting diode(s) are spaced from the surface to be cleaned, and are configured to selectively concurrently direct overlapping, at least partially, acoustic waves and light energy towards the surface to facilitate removal of particles by breaking bonds between the particles and the surface.

### BACKGROUND

This invention relates generally to semiconductor fabrication processes, and more particularly, to apparatuses and methods for facilitating removal of particles from surfaces, such as from a surface of a reticle, mask, mask blank, wafer, substrate, glass plate, flat panel, etc.

Removal of sub-100 nanometer (nm) particles from a surface can be a challenging subject for semiconductor fabrication processes. These particles may include contaminants on the surface including materials such as organic material, dust, residue, and metal impurities. Generally, the particles may accumulate when the substrate is being stored or is in a stand-by state between successive processes, and the accumulated particles may cause defects, particularly for integrated circuits on a substrate.

The surface-particle interactions depend on the material and the surface structure. As such, the energy transfer efficiency needed to remove a particle from a surface strongly depends on the size of the particle on the surface. Generally, adhesive forces between a particle and the surface need to be broken and the particle needs to be transported far enough away from the surface to ensure that the particle will not be re-deposited on the surface.

Prior methods for removing particles include wet cleaning techniques that involve immersing a substrate in a series of chemical solutions or spraying a series of chemical solutions onto a substrate, including for example, hydrofluoric acid, hydrogen peroxide solution, sulfuric acid, etc. In some techniques, a spin brush may be included. However, these processes are both expensive and produce waste that is environmentally harmful. Additionally, the use of a spin brush can be effective in removing large particles, but is not particularly effective in removing particles on the order of sub-microns or smaller.

Additionally, Next Generation Lithography (NGL) used in semiconductor technology includes reflective optics on glass substrates which have a surface roughness of approximately 1.5 Angstrom RMS or less to prevent scattering of the light, which may degrade the lithography process performance. According to International Technology Roadmap for Semiconductor (ITRS), the critical defect size that needs to be removed from surface depends on the half pitch (HP) of technology node used for building that device. For example, ITRS requires that all particles larger than 14 nm be removed from wafer surface in front-of-the line processes used for fabrication of transistors based on FLASH memory technology. Similarly, particles larger than about 12 nanometers need to be removed from the surface of an Extreme Ultraviolet (EUV) mask substrate that is used for 26 nm NGL. Conventional wet cleaning techniques that use under etching of particles to remove particles from a surface are not applicable in this situation since they increase the surface roughness beyond the required value. In addition, many advanced cleaning tools do not have the ability to totally remove particles with these dimensions, from the surface of a plate. This is due to the lack of a mechanism to convey a relatively high energy or momentum to the particles in the vicinity (few nanometers) of the surface. Additionally, current tools typically lack a mechanism to increase the population of reactive species in the vicinity of the liquid-surface interface.

### BRIEF SUMMARY

In one aspect, the shortcomings of the prior art are overcome and additional advantages are provided through the provision of an apparatus which includes a cleaning tool for fabricating removal of particles from a surface cleaned. The cleaning tool includes: at least one acoustic wave generator to direct acoustic waves towards the surface to be cleaned, the at least one acoustic wave generator including an acoustic transducer which facilitates generating the acoustic waves and an acoustic coupler substrate through which the acoustic waves propagate; and at least one light source, coupled to the acoustic coupler substrate of the at least one acoustic wave generator, to direct light towards the surface to be cleaned. The at least one acoustic wave generator and the at least one light source are spaced from the surface to be cleaned, and are configured to selectively concurrently direct overlapping, at least in part, acoustic waves and light towards the surface to facilitate removal of particles from the surface.

In another aspect, an apparatus is provided which includes a cleaning tool for facilitating removal of particles from a surface. The cleaning tool includes: an acoustic wave generator to direct acoustic waves towards the surface to be cleaned, the acoustic wave generator including an acoustic transducer which facilitates generating the acoustic waves and an acoustic coupler substrate through which the acoustic waves propagate; and a plurality of light-emitting diodes to direct light towards the surface to be cleaned, the plurality of light-emitting diodes being coupled to the acoustic coupler substrate and disposed between the acoustic coupler substrate of the acoustic wave generator and the surface to be cleaned, the acoustic wave generator and the plurality of light-emitting diodes being spaced from the surface to be cleaned, and configured to selectively concurrently direct overlapping, at least in part, acoustic waves and the light towards the surface to facilitate removal of particles from the surface.

In a further aspect, a method is provided which includes providing a cleaning tool for facilitating removal of particles from a surface. The providing of the cleaning tool includes: providing at least one acoustic wave generator to direct acoustic waves towards the surface to be cleaned, the at least one acoustic wave generator including an acoustic transducer which facilitates generating the acoustic waves and an acoustic coupler substrate through which the acoustic waves propagate; and providing at least one light source to direct light towards the surface to be cleaned, the at last one light source being coupled to the acoustic coupler substrate of the at last one acoustic wave generator, and the at least one acoustic wave generator and the at least one light source being spaced from the surface to be cleaned, and configured to selectively concurrently direct overlapping, at least in part, acoustic waves and light towards the surface to facilitate removal of particles from the surface.

Additional features and advantages are realized through the techniques of the present invention. Other embodiments and aspects of the invention are described in detail herein and are considered a part of the claimed invention.

### BRIEF DESCRIPTION OF THE SEVERAL VIEWS OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1A is a top plan view of one embodiment of a cleaning apparatus, which may incorporate a cleaning tool, in accordance with one or more aspects of the present invention;

FIG. 1B is a side elevational view of the cleaning apparatus of FIG. 1A, in accordance with one or more aspects of the present invention;

FIG. 2 is a side elevational view of a further embodiment of the cleaning apparatus of FIGS. 1A & 1B, in accordance with one or more aspects of the present invention;

FIG. 3 is a schematic of one embodiment of another cleaning apparatus, which may incorporate a cleaning tool, in accordance with one or more aspects of the present invention;

FIG. 4 is a partial schematic of one embodiment of a cleaning tool, in accordance with one or more aspects of the present invention;

FIG. 5 depicts an alternate embodiment of a cleaning tool, in accordance with one or more aspects of the present invention;

FIG. 6 is a partial plan view of one embodiment of a cleaning tool with a plurality of light-emitting diodes, multiple radical sensors, and one or more hydrophone sensors arrayed on a surface of an acoustic coupler substrate of an acoustic wave generator of the cleaning tool, in accordance with one or more aspects of the present invention;

FIG. 7A partially depicts an alternate embodiment of a cleaning tool, in accordance with one or more aspects of the present invention;

FIG. 7B depicts an enhanced embodiment of the cleaning tool of FIG. 7A, in accordance with one or more aspects of the present invention;

FIG. 7C is a cross-sectional elevational view of one embodiment of the cleaning tool of FIG. 7B, taken along line 7C-7C thereof, in accordance with one or more aspects of the present invention;

FIG. 8A depicts another embodiment of a cleaning tool, in accordance with one or more aspects of the present invention;

FIG. 8B is a plan view of one embodiment of a surface acoustic wave (SAW) module which may be employed in a cleaning tool, in accordance with one or more aspects of the present invention;

FIG. 8C is a cross-sectional elevational view of the cleaning tool of FIG. 8A, taken along line 8C-8C thereof, in accordance with one or more aspects of the present invention;

FIG. 9A depicts another embodiment of a cleaning tool, in accordance with one or more aspects of the present invention;

FIG. 9B is an enlarged depiction of one embodiment of the interdigitated SAW electrodes employed in one embodiment of the cleaning tool of FIG. 9A, in accordance with one or more aspects of the present invention;

FIG. 9C is a top plan view of the cleaning tool of FIG. 9A, in accordance with one or more aspects of the present invention;

FIG. 9D depicts an alternate embodiment of the cleaning tool of FIG. 9A, in accordance with one or more aspects of the present invention;

FIG. 10A graphically depicts hydroxyl-radical generation using a cleaning tool with ultraviolet light-emitting diodes, in accordance with one or more aspects of the present invention; and

FIG. 10B graphically depicts hydroxyl-radical generation using a cleaning tool with megasonic acoustic waves, in accordance with one or more aspects of the present invention.

### DETAILED DESCRIPTION

Aspects of the present invention and certain features, advantages, and details thereof, are explained more fully below with reference to the non-limiting examples illustrated in the accompanying drawings. Descriptions of well-known materials, fabrication tools, processing techniques, etc, are omitted so as not to unnecessarily obscure the invention in detail. It should be understood, however, that the detailed description and the specific examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure. Note also that reference is made below to the drawings, which are not drawn to scale to facilitate an understanding of the invention, wherein the same or similar reference numbers used throughout different figures designate the same or similar components.

As noted, conventional wet-cleaning techniques that use under-etching of particles to remove particles from the surface may result in undesirable roughening of the surface, and thus, may no longer be acceptable for today's semiconductor fabrication processes. Other examples for removing particles from a surface include transferring of energy to a particle, where the energy transfer efficiency to the particle on the surface strongly depends on the size of the particle on the surface. This method is best used to remove “soft” defects, such as particles that adhere to a surface due to van der Waals and electrostatic forces. Other particles that are chemically bonded to a surface are more difficult to remove. These particles are referred to as “hard” defects.

By way of example, energy can be transferred to particles on a surface by flowing a cleaning fluid over the surface. Unfortunately, close to the surface, there is a hydrodynamic boundary layer, which is a region immediately adjacent to the surface, with little or no flow. This boundary layer may have a thickness of a micron or more, while the particle to be removed may be a nanometer-scaled particle, making it difficult to remove such particles from the surface using conventional cleaning fluid flow approaches.

Advantageously, disclosed herein are various enhanced cleaning apparatuses and methods which facilitate removing surface particles in the nano-scale size, or larger, including, for instance, dust, organic materials, metal impurities, etc.

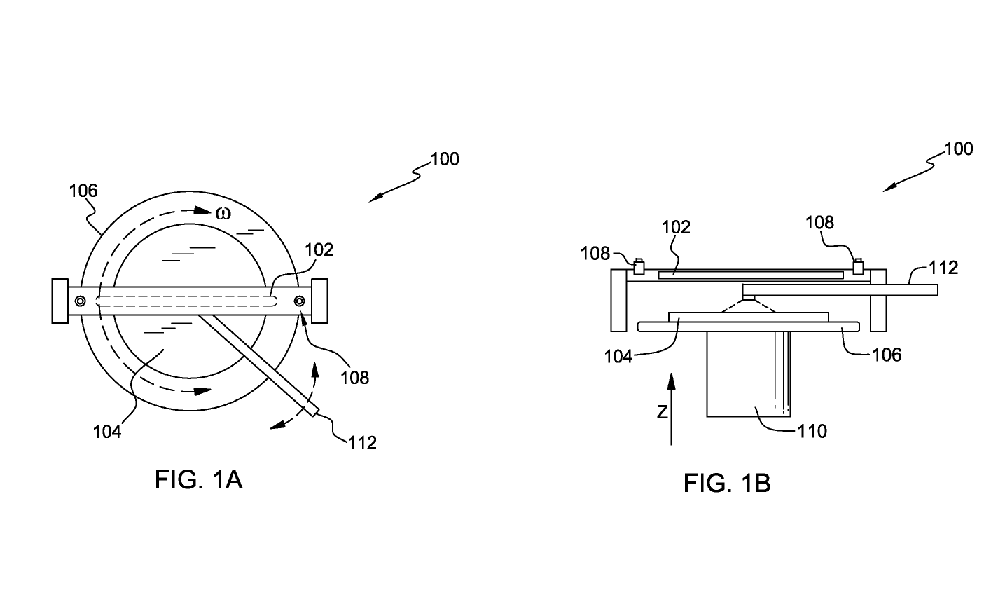

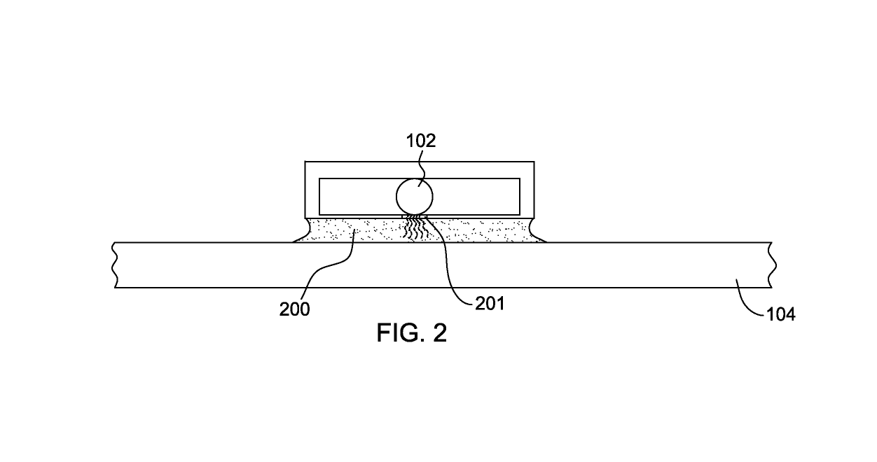

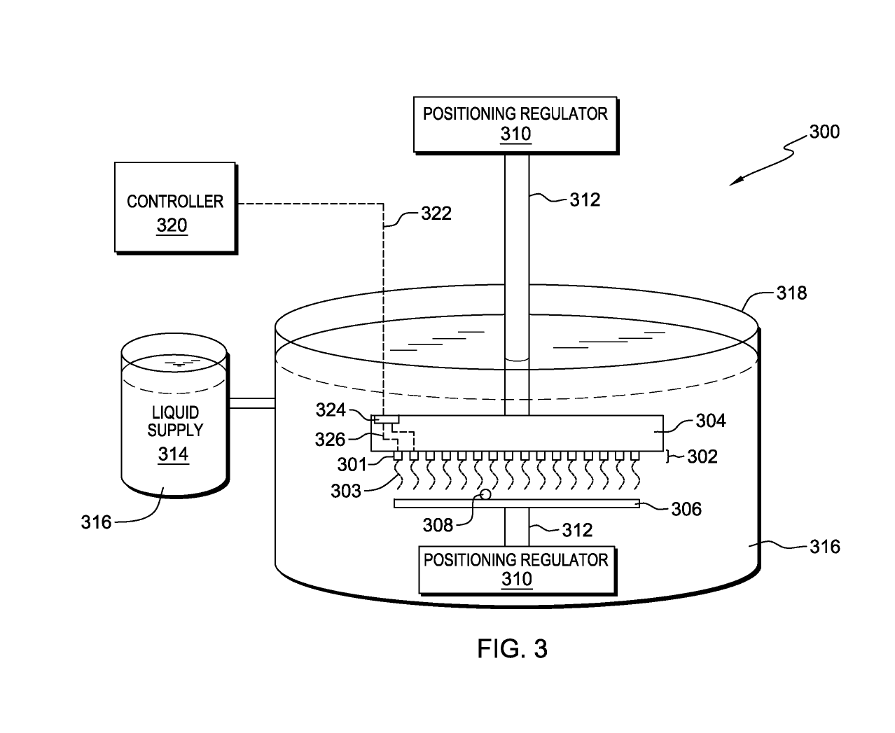

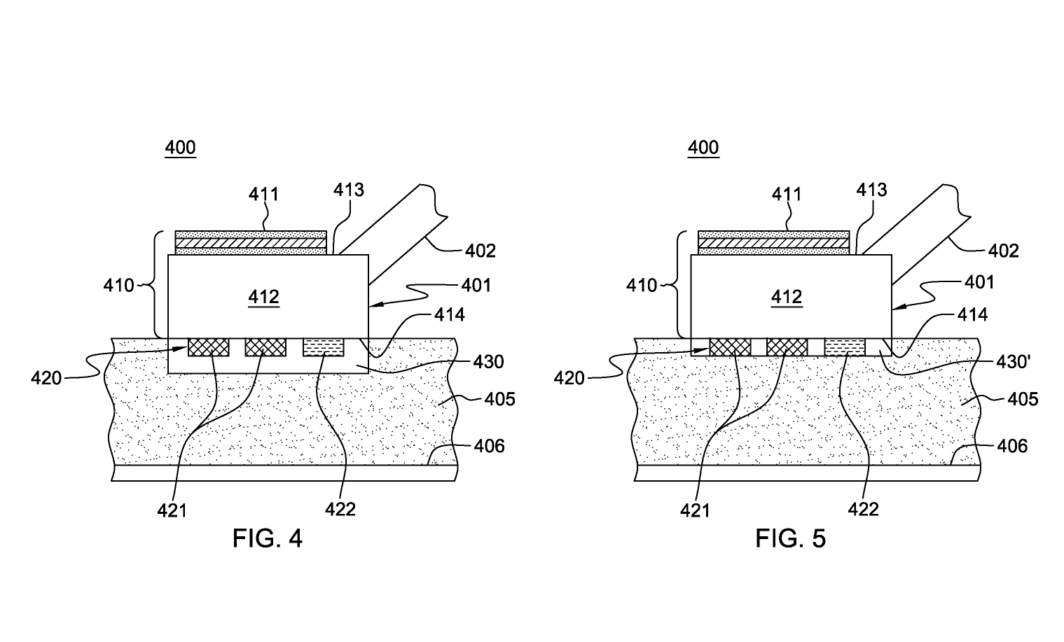

In one embodiment a light source, such as, an ultraviolet (UV) light source or a vacuum UV (VUV) light source, may be provided to facilitate breaking the chemical bonds between the particles and the surface. Additionally, a light source may create ozone and other reactive oxygen radicals, which may enhance cleaning performance. In another embodiment, an acoustic wave source is provided for breaking bonds between the surface and particles to be removed. Additionally, the acoustic wave source may create hydroxyls and other active oxygen radicals, which may also enhance cleaning performance. In still another embodiment, an opto-acoustic cleaning tool is disclosed, combining advantages of both light cleaning and acoustic wave cleaning Embodiments of an ultraviolet light cleaning apparatus are described below with reference to FIGS. 1A-2, an embodiment of an acoustic wave cleaning apparatus is discussed below with reference to FIG. 3, and various embodiments of light-assisted acoustic (or opto-acoustic) cleaning tools are described below with reference to FIGS. 4-10B, which may be employed in or incorporated into cleaning apparatuses, such as the apparatuses of FIGS. 1A-3.

FIGS. 1A & 1B depict a top-view and side-view, respectively, of an in-situ cleaning apparatus 100. In one embodiment, this cleaning apparatus may include an a light source 102 located inside a process chamber (not shown) and placed over a surface 104 to be cleaned, for use during different processes inside the process chamber. The distance between surface 104 (e.g., a glass substrate, a glass surface, a silicon substrate, plate, photo-mask substrate, etc.) and light source 102 may be controlled, for instance, by vertically adjusting rotating chuck 106 using, for instance, a motor 110. Alternatively, the distance between surface 104 and light source 102 may be controlled by moving light source 102 in a vertical direction.

In one embodiment, light source 102 may be a side-on lamp, a head-on lamp, a pen-shape long lamp, or an array of point sources, and may operate with a wavelength of about 140 to 1,000 nanometers (nm) at an intensity of about 1 m W/cm² or higher, preferably higher than 5 m W/cm². Examples of light source 102 may include, without limitation, a high pressure mercury lamp (wavelength of about 250-450 nm), a low pressure mercury lamp (wavelength of about 180-480 nm), UV light emitting and/or laser diodes (wavelength of about 200-400 nm), a metal halide lamp (wavelength of about 200-450 nm), an Xe² excimer lamp (wavelength of about 172 nm), an Ar² excimer lamp (wavelength of about 146 nm), a KrCl excimer lamp (wavelength of about 222 nm), an XeI excimer lamp (wavelength of about 254 nm), an XeCl excimer lamp (wavelength of about 308 nm), an ArF excimer laser (wavelength of about 193 nm), a KrF excimer laser (wavelength of about 248 nm), and an F² laser (wavelength of about 157 nm). Alternatively, the light source may be implemented using a visible or infrared light.

As shown in FIG. 2, in one embodiment, the in-situ cleaning apparatus 100 may dispense liquid 200 onto the surface 104 substantially simultaneously with the irradiation of light. The liquid may be sprayed onto the surface using a moving (swivel) arm 112 (see FIGS. 1A & 1B). Alternatively, the liquid may be dispensed using a beam nozzle. The liquid may include, without limitation, deionized water (DIW), ozonated water, hydrogen water, ammonium hydroxide, isopropanol alcohol, hydrofluoric acid, hydrogen peroxide solution, sulfuric acid, and/or any combinations of these solutions. In one embodiment, swivel arm 112 may dispense ozonated water and/or hydrogen peroxide solution onto the surface needing to be cleaned substantially simultaneous with radiation of light having, for instance, a wavelength of about 250 to 260 nm. In this example, the combination of the light with a wavelength of about 250 to 260 nm and the ozone molecules dissolved in water (e.g., minimizing exposure to an air interface) may generate highly reactive species, such as hydroxy radicals (OH*), super oxide (O₂⁻), hydroxyl-peroxide (HO₂) and oxygen radicals (O₂*), to enhance particle removal from the surface. Here, the flow rate of the solution to be dispensed onto the surface may be controlled to form a liquid film on the whole surface area of the plate or substrate. For example, the flow may range from about 10 milliliters per minute to about 2 liters per minute for substrates such as, without limitation, 6 square inch glass substrates. Surface 104, coupled to rotating chuck 106 and motor 110, may be rotated at about 1 to 3000 revolutions per minute (rpm) during its exposure to light, which distributes the liquid (e.g., ozoned liquid) substantially uniformly over the surface of interest and prevent from the re-deposition of removed particles onto the surface.

In certain embodiments, a liquid may be dispensed to substantially fill the space between the light source and the surface to be cleaned. In one embodiment, light source 102 may be covered by a transparent window 201 and a mirror that allows the light to pass through the window. The space surrounded by the window and the mirror may be purged with inert gas such as, but not limited to, nitrogen (N₂), Helium (He), Argon (Ar), or Krypton (Kr) to prevent losing light intensity due to absorption by air and moisture. When light source 102 is situated close to the surface to be cleaned with a separation distance of about a few hundreds or thousands of microns, a confined liquid layer 200 may stay between surface 104 and light source 102 due to capillary forces. As such, there may be substantially no liquid-to-air interface and ozone may form inside the liquid. Additionally, the light source 102 may be controlled to a position to allow the confined liquid layer to remain between the light source and the surface. This substantially prevents any ozone created within the liquid layer from diffusing into the gas phase because there is substantially no interface between the liquid and the gas, and thus, the liquid is capable of dissolving a high concentration of ozone. Since the distance between the light source and the surface is minimal in this configuration, light with higher intensity may radiate the surface to create more ozone and other oxygen radicals within the liquid film. In this configuration, with an aqueous solution such as de-ionized water and ammonia water exposed to the light with a wavelength shorter than 200 nm, ozone and some highly reactive species, such as hydroxy radicals (OH*), super oxide (O₂⁻), hydroxyl-peroxide (HO₂) and oxygen radicals (O₂*), may be generated in the water layer and particles may be removed efficiently because the high oxidation strengths are enough to dissolve the organic material. As such, a low pressure mercury lamp (wavelength of about 180-480 nm), an ArF excimer laser (wavelength of about 193 nm), an Xe² excimer lamp (wavelength of about 172 nm), F² laser (wavelength of about 157 nm) or an Ar² excimer lamp (wavelength of about 146 nm), as well as other light sources, including light-emitting diodes, may be used as the light source.

The cleaning apparatuses of FIGS. 1A, 1B & 2, may be integrated into existing wet cleaning tools (e.g., stripping tools, etching tools, etc.) for removing contaminant particles on both masks and wafers and other surfaces of interest, including, without limitation, plates used for liquid crystal display (LCD). Additionally, the in situ UV cleaning apparatus may be used during spin dry processes. The application of light energy may change the condition of most surfaces of interest to hydrophilic, which leads to a lower number of particles both in spin drying and surface-tension-gradient based drying processes in the cleaning apparatus or tool.

In operation, a liquid (e.g., ozonated water) may be dispensed onto the surface to form a liquid film with a thickness of about 200 to 300 micrometers to dissolve or oxidize the particles. Next, a light source may be brought into close proximity (e.g., about 200 micrometers) to the surface of interest to expose the surface. In some embodiments, this step may occur substantially simultaneous with dispensing of the liquid. Due to surface tension between the light source window and the liquid layer and surface tension between the liquid layer to substrate surface, a meniscus of liquid may form and the liquid may be trapped between the two solid surfaces. Depending on the material of these surfaces and the nature of liquid used, the liquid layer thickness can be as large as about 1000 μm. As such, the light source may create ozone close to the surface to be cleaned. In one embodiment, the ozone may be at the interface between a liquid layer and the surface. Therefore, a higher rate of chemical reactions at the surface-to-liquid interface may occur. Additionally, the introduction of ozone and other oxygen radicals may dissociate chemical bonds more effectively to remove particles from the surface to be cleaned. In other embodiments, the light source may moist the surface to be cleaned, turning the surface into a hydrophilic surface, which is known to lead to lower adhered particles after drying. A gas may also be introduced for cooling the light source. Alternatively, the gas may be used to react with contaminants on the surface and aid in the breaking of chemical bonds between particles and the surface to be cleaned.

Note that the apparatuses and techniques disclosed herein are not limited to ozonated water and may be applied together with other chemicals commonly used in wet cleaning of semiconductor structures. For example, ozonated water, hydrogen water, ammonia water, hydrogen peroxide solution, sulfuric acid, organic acid or a mixture of any these solutions may be used to enhance particle removal capability. In some embodiments, light with a wavelength of about 140 to about 260 nm may be used. Alternatively, light with a wavelength of about 140 to about 200 nm may be advantageous due to the efficient creation of ozone and excited radicals. For example, a Xe² excimer lamp (wavelength of about 172 nm), mercury lamp (wavelength of about 180 to 450 nm), a F² laser (wavelength of about 157 nm), a Kr excimer lamp (wavelength of about 146 nm) or light-emitting diodes may be used as examples of the light source. Additionally, excited oxygen radicals and ozone may be generated in deionized water with the substantially simultaneous irradiation of light with a wavelength of less than about 200 nm. Since they have high oxidation strengths enough to dissolve the organic material, the light radiation into the solutions listed above may enhance removal of particles from the surface to be cleaned.

As noted initially, FIG. 3 depicts one embodiment of a cleaning apparatus 300 for, at least in part, cleaning a surface with acoustic waves (for instance, using a gigasonic brush). In one embodiment, cleaning apparatus 300 may include an array 302 of acoustic transducers 301, with (for instance) individual acoustic transducers 301 having sizes, for instance, in the range of 9 μm² to 250,000 μm². In one embodiment, the resonant frequency of an acoustic transducer 301 is inversely proportional to the size of the acoustic transducer 301. The size of acoustic transducers 301, and the material that comprises the acoustic transducers 301 may cause the array 302 of acoustic transducers 301 to emit acoustic waves 303 with frequencies in the range of, for instance, 10 megahertz to 10 gigahertz. Unlike megasonic systems that only utilize cavitation only, apparatus 300 may generate acoustic waves 303 in the frequency range of 10 megahertz to 10 gigahertz and remove a particle 308 with a diameter anywhere in a range of 1 to 500 nanometers through direct excitation of the particle 308. The acoustic transducers 301 may generate acoustic waves 303 at or around the resonant frequency of particle 308, directly exciting the particle 308, and causing the particle 308 to dislodge from the surface 306 to be cleaned. In alternative embodiments, apparatus 300 may cause direct excitation alone to remove particles, or it may cause direct excitation in conjunction with other mechanisms, such as cavitation, to facilitate particle removal.

More particularly, as illustrated in FIG. 3, cleaning apparatus 300 may include an array 302 of acoustic transducers 301 coupled to a support substrate 304. In one embodiment, the array 302 of acoustic transducers 301 is positioned close to the surface 306 to be cleaned. Apparatus 300 may also include a liquid supply 314 of cleaning liquid 316 and (in one embodiment) a tank 318, which may hold cleaning liquid 316 that couples array 302 of acoustic transducers 301 to the surface 306 to be cleaned. A positioning mechanism 312 may be coupled to at least one of the array 302 of acoustic transducers 301 or the surface 306. A positioning regulator 310 may control positioning mechanism 312 and set the position of array 302 of acoustic transducers 301 relative to surface 306. A controller 320 may activate and deactivate the array 302 of acoustic transducers 301 by sending one or more signals, or by applying one or more voltage(s). In one embodiment, controller 320 may be coupled to a signal bus 322, and an interface 324 on or within support substrate 304 may couple signal bus 322 to internal routing 326, which couples to the acoustic transducers 301.

As noted above, in certain embodiments, surface 306 may comprise a surface of a semiconductor wafer. In other embodiments, surface 306 may be a surface of a liquid crystal display, a mask, mask blank, substrate, glass plate, etc., including, but not limited to, surfaces involved in a semiconductor manufacturing process.

The array 302 of acoustic transducers 301 may include one or more individual acoustic transducers 301 coupled, in this embodiment, to an overlaying support substrate 304. Substrate 304 may include substrate materials such as silicon, quartz, lithium niobate, silicon carbide, or other materials that are suitable for coupling acoustic transducers 301 to the support substrate 304. In a further embodiment, support substrate 304 may itself comprise piezoelectric transducer materials. In such an embodiment, substrate 304 may substantially comprise a lower frequency transducer for causing, for example, cavitation bubbles in cleaning liquid 316.

As noted, array 302 of acoustic transducers 301 may couple to surface 306 through cleaning liquid 316. In one embodiment, cleaning liquid 316 may be water, which may be deionized, distilled, or purified by other means. In other embodiments, cleaning liquid 316 may be a chemical solution, such as the solutions referenced above in connection with the embodiments of FIGS. 1A-2.

In one embodiment, cleaning liquid supply 314 may dispense cleaning liquid 316 into tank 318, and the array 302 of acoustic transducers 301 and the surface 306 may be coupled to each other through cleaning liquid 316 by immersion in cleaning liquid 316 within tank 318. In an alternate embodiment (not shown), cleaning liquid 316 may be dispensed directly between the array 302 of acoustic transducers 301 and the surface 306, for instance, using a spray arm configuration (not shown).

In one embodiment, acoustic waves 303 generated by array 302 of acoustic transducers 301 may be absorbed by cleaning liquid 316 as the acoustic waves 303 travel through the cleaning liquid 316. Because higher frequency acoustic waves may be absorbed by cleaning liquid 316 faster than lower frequency acoustic waves, the application range may vary depending upon the frequency of the acoustic waves 303 being emitted from array 302 of acoustic transducers 301. In certain embodiments, positioning mechanisms 312 may adjust the position the array 302 of acoustic transducers 301 to within, for instance, 1 millimeter of the surface 306 to be cleaned. In other embodiments, positioning mechanism 312 may position array 302 of acoustic transducers 301 at different distances from surface 306, depending in part on the frequency or frequencies of the acoustic waves 303 being emitted and the rate at which the acoustic waves 303 dissipate in the cleaning liquid 316.

In one embodiment, positioning mechanism 312 may be coupled directly to substrate 304 or surface 306, or indirectly to substrate 304 and/or surface 306 through one or more coupling members (not shown). In a particular embodiment, positioning regulator 310 is coupled to positioning mechanism 312, and is configured to control the position of array 302 of acoustic transducers 301 and/or surface 306 by moving positioning mechanism 312. In alternate embodiments, positioning mechanism 312 may be coupled to substrate 304 and target surface 306. In some embodiments, positioning mechanism 312 may be connected to substrate 304, but not to surface 306. For instance, surface 306 may be in a static position during positioning of the array 302 of acoustic transducers 301. In other embodiments, positioning mechanism 312 may be coupled to surface 306, but not to substrate 304. In such a case, the array 302 of acoustic transducers 301 may be in a static position during positioning of the surface 306.

Positioning regulator 310 may include a machine or machines executable instructions. For example, positioning regulator 310 may include a hardware circuit comprising custom VLSI circuits or gate arrays, off-the-shelf semiconductors such as logic chips, transistors, or other discrete components. Positioning regulator 310 may also include one or more programmable hardware devices such as one or more processors, special purpose microprocessors, field programmable gate arrays, programmable array logic, programmable logic devices or the like.

Positioning regulator 310 may also include software modules, which may include software-defined units or instructions, that when executed by a processing machine or device, transform data stored on a data storage device from a first state to a second state. An identified module of executable code may, for instance, comprise one or more physical or logical blocks of computer instructions which may be organized as an object, procedure, or function. Nevertheless, the executables of an identified module need not be physically located together, but may comprise disparate instructions stored in different locations which, when joined logically together, comprise the module, and when executed by the processor, achieve the stated function.

In one embodiment, apparatus 300 includes controller 320, which activates some or all of the acoustic transducers 301 in array 302. The controller may send an activation signal or activation signals through signal bus 322. An interface 324 on the substrate 304 may connect the signal bus 322 to internal routing 326, which couples to acoustic transducers 301 in array 302. In some embodiments, controller 320, signal bus 322, interface 324, and internal routing 326 may be configured to send a single activation signal to the entire array 302 of acoustic transducers 301. In other embodiments, controller 320, signal bus 322, interface 324, and internal routing 326 may be configured to send separate activation signals to different individual acoustic transducers 301 and groups of individual acoustic transducers 301 within array 302 of acoustic transducers 301. In further embodiments, controller 320, signal bus 322, interface 324, and internal routing 326, may be configured to send separate activation signals to each individual acoustic transducer 301 within array 302 of acoustic transducers 301. An activation signal may be the activation power required to activate one or more acoustic transducers, or an enabling signal for control circuitry (not shown) that may be built on substrate 304 to direct activating power to one or more of acoustic transducers 301 in the array 302.

Controller 320 may include a machine (or machines) executable instructions. For example, controller 320 may be implemented as a hardware circuit comprising custom VLSI circuits or gate arrays, off-the-shelf semiconductors such as logic chips, transistors, or other discrete components. Controller 320 may also be implemented in programmable hardware devices such as processors, special purpose microprocessors, field programmable gate arrays, programmable array logic, programmable logic devices or the like.

Further, controller 320 may include software modules, which may comprise software-defined units or instructions, which when executed by a processing machine or device, transform data stored on a data storage device from a first state to a second state. An identified module of executable code may, for instance, comprise one or more physical or logical blocks of computer instructions which may be organized as an object, procedure, or function. Nevertheless, the executables of an identified module need not be physically located together, but may comprise disparate instructions stored in different locations which, when joined logically together, comprise the module, and when executed by the processor, achieve the stated data transformation.

As noted initially, also disclosed herein are apparatuses and cleaning processes employing a cleaning tool which combines (for instance, integrates) one or more light source(s) and one or more acoustic wave generator(s). Generally stated, an acoustic wave generator as used herein includes one or more acoustic transducers and one or more acoustic coupler substrates. An acoustic transducer facilitates generating acoustic waves from, for instance, one or more electrical signals applied to the acoustic transducer, and the one or more acoustic coupler substrates are configured and selected to facilitate directing of the acoustic waves towards the surface to be cleaned.

The resultant light-assisted acoustic cleaning tool, or opto-acoustic cleaning tool, can provide enhanced removal of particles from a surface to be cleaned, such as a surface of a reticle, mask, mask blank, wafer, substrate, glass plate, flat panel, etc. By way of specific example, during manufacture of advanced transistors, one or more monolayers of materials may be used. Such monolayers are referred to as 2-D materials, and are typically deposited by atomic layer deposition (ALD). For instance, interlayer dielectrics (ILDs) (e.g., SiO₂), with a thickness of 1.2 nm, or grapheme, have such 2-D structure. Extreme process control is needed to clean or etch a layer of one or a few monolayers. Since the reaction rate of chemical reactions depends on temperature, it is necessary to have extremely precise temperature control on the whole wafer to ensure cleaning chemicals do not etch the one or more monolayers. In comparison, in light-assisted acoustic cleaning such as disclosed herein, the chemical reactions may be controlled via application of light and acoustic waves, both of which may be controlled to a much higher precision level than temperature throughout the wafer. Thus, the concepts disclosed herein are especially useful in advanced technology nodes, where contamination needs to be removed, for instance, from atomic layer deposited monolayers.

Various embodiments for combining a light source(s) with an acoustic wave generator(s) are depicted in FIGS. 4-9D, and described below.

Generally stated, the enhanced opto-acoustic apparatus and method disclosed herein comprise or provide a cleaning tool which facilitates removal of particles from a surface, of a reticle, mask, mask blank, wafer, substrate, glass plate, etc. The cleaning tool includes one or more acoustic wave generators configured and disposed to direct acoustic waves towards the surface to be cleaned, and one or more light sources coupled to the acoustic wave generator(s) and configured and disposed to direct light towards the surface to be cleaned. The at least one acoustic wave generator includes an acoustic transducer which facilitates generating the acoustic waves, and an acoustic coupler substrate through which the acoustic waves propagate, at least in part, towards the surface to be cleaned. In the embodiments presented, the one or more light sources are coupled to the acoustic coupler substrate of the acoustic wave generator(s). For instance, in one embodiment, the light source(s) is directly physically attached to the acoustic coupler substrate of the acoustic wave generator(s). Advantageously, the one or more acoustic wave generators and one or more light sources are spaced from the surface to be cleaned, and configured to selectively concurrently direct overlapping, at least partially, acoustic waves and light towards the surface to facilitate removal of particles from the surface by breaking particle bonds to the surface, for instance, in a manner as separately described above in connection with the cleaning apparatuses of FIGS. 1A-3. Such an enhanced opto-acoustic apparatus and method advantageously delivers greater energy to the particles to be removed using, in one or more embodiments, concurrently delivered acoustic wave energy and light energy. Further, both soft defects and hard defects may be concurrently addressed using the enhanced opto-acoustic apparatus and method presented. Various parameters may be controlled by one of ordinary skill in the art to, for instance, control energy delivered to the particles at the surface, as well as control radicals within the fluid exposed to the surface to facilitate, for instance, removal of particles that are chemically bonded to the surface.

Note that the opto-acoustic apparatus and method disclosed herein may, for instance, employ light of a wavelength which depends on the nature of the particle or contamination to be removed. In general, the light wavelength may be anywhere from the ultra-violet to the infrared region. Ultra-violet light can be used to facilitate breaking double bonds in, for instance, carbon molecules, whereas infrared light will be more effective in heating particles by absorption in the infrared region. Additionally, the acoustic transducer can operate in a frequency range from kilohertz up to gigahertz. Further, the acoustic transducer can be built using, for instance, standard electrodes on piezoelectric materials, or by use of one or more surface acoustic wave (SAW) devices.

As noted, FIG. 4 depicts one embodiment of a cleaning apparatus, generally denoted 400, comprising a cleaning tool 401 supported by a support arm or positioning regulator 402. In this embodiment, cleaning tool 401 comprises, an acoustic wave generator structure 410, and multiple light sources 420, such as multiple light-emitting diodes. In the embodiment depicted, cleaning tool 401 is spaced from a surface 406 to be cleaned of particles, and a fluid 405, such as one or more of the above-described cleaning fluids, substantially fills the space between cleaning tool 401 and surface 406 to be cleaned.

In one embodiment, acoustic wave generator 410 includes one or more acoustic transducers 411 capable of being activated to generate acoustic waves, and an acoustic coupler substrate 412, through which generated acoustic waves propagate towards surface 406. In one embodiment, acoustic transducer(s) 411 is (are) affixed to a first surface 413 of acoustic coupler substrate 412, and the multiple light sources 420 are supported by or affixed to a second surface 414 of acoustic coupler substrate 412, with first surface 413 and second surface 414 being opposing surfaces of acoustic coupler substrate 412. Note that, in one embodiment, second surface 414 of acoustic coupler substrate 412 faces (that is, is in opposing relation to) the surface 406 to be cleaned of particles. In certain embodiments, the multiple light sources 420 may comprise a plurality of light-emitting diodes 421, 422, which may include one or more first light-emitting diodes 421 of a first wavelength, and one or more second light-emitting diodes 422 of a second wavelength, wherein the first and second wavelengths are different wavelengths, that is, the first and second light-emitting diodes generate light of different wavelengths to facilitate removal of different sized particles. For instance, the different wavelengths may comprise different wavelengths in the range of 200 to 400 nanometers. In one specific example, the first wavelength may be approximately 256 nm, and the second wavelength 345 nm. Note that any desired number of light-emitting diodes of any desired number of wavelengths may be coupled in any desired arrangement to acoustic coupler substrate 412, and in particular, to second surface 414 of acoustic coupler substrate 412, to achieve a desired cleaning tool configuration and operation.

By way of more specific example, multiple light-emitting diodes may be built on, or coupled, or affixed to, etc., an acoustic coupler substrate material, such as a quartz or sapphire substrate of the acoustic wave generator. In one embodiment, light-emitting diodes with different wavelengths may be mounted to the same acoustic coupler substrate on one side thereof. The acoustic transducer(s) 411 may be implemented, in one embodiment, as a piezoelectric transducer(s), which is also coupled to acoustic coupler substrate 412 at, for instance, an opposing side of the acoustic coupler substrate. A protective layer 430, such as a protective transparent layer, at least partially surrounds the light-emitting diodes 422, 423. In one implementation, the protective layer may comprise a protective coating over the light-emitting diodes, such as, for instance, a sapphire coating, particularly in an implementation where the acoustic coupler substrate 412 itself comprises sapphire as the acoustic wave coupling material through which the acoustic waves propagate. In one embodiment, GaN, AN, AlGaN may be employed in fabricating the light-emitting diodes 421, 422, and can also be used in fabricating the acoustic transducer(s) 411, for instance, the one or more piezoelectric transducers. Alternatively, the sapphire substrate can be used as a protection surface. In this case, the light of light-emitting diodes can pass through sapphire and reach the surface to be cleaned. In one configuration, acoustic transducer(s) 411 can be built on top of the light-emitting diodes 420. The light-emitting diodes may be driven in a pulse mode to improve power density, with the electrodes (not shown) of the light-emitting diodes being fabricated and configured to allow (in one embodiment) for the propagation of the acoustic waves, at least in part, through the light-emitting diodes. That is, acoustic waves generated by the acoustic transducer(s) 411 may propagate through acoustic coupler substrate 412, and then through light-emitting diodes 421, 422, and protective layer 430, into fluid 405 towards surface 406 to be cleaned.

FIG. 5 depicts the apparatus 400 and cleaning tool 401 of FIG. 4, with protective layer 430′ having a reduced thickness compared with protective layer 400 of FIG. 4. In the embodiment of FIG. 5, protective layer 430′ has (for instance) a minimum thickness sufficient to protect the light-emitting diodes of the cleaning tool from cleaning solution 405. The minimum thickness may be desirable to minimize effect on acoustic waves and light propagating from cleaning tool 401 towards surface 406 to be cleaned. Note also with reference to the cleaning apparatus embodiments of FIGS. 4 & 5, that light produced by the light sources 420 overlaps, at least in part, the acoustic waves produced by the one or more acoustic transducers 411 since, in the embodiments depicted, the light sources are disposed below the acoustic wave generator, being coupled in one embodiment to the acoustic coupler substrate surface facing surface 406 to be cleaned. In this embodiment, when acoustic waves are generated concurrent with the light, the acoustic waves and light overlap, at least in part, and a portion of the acoustic waves may propagate through the light sources, which as noted, may comprise light-emitting diodes.

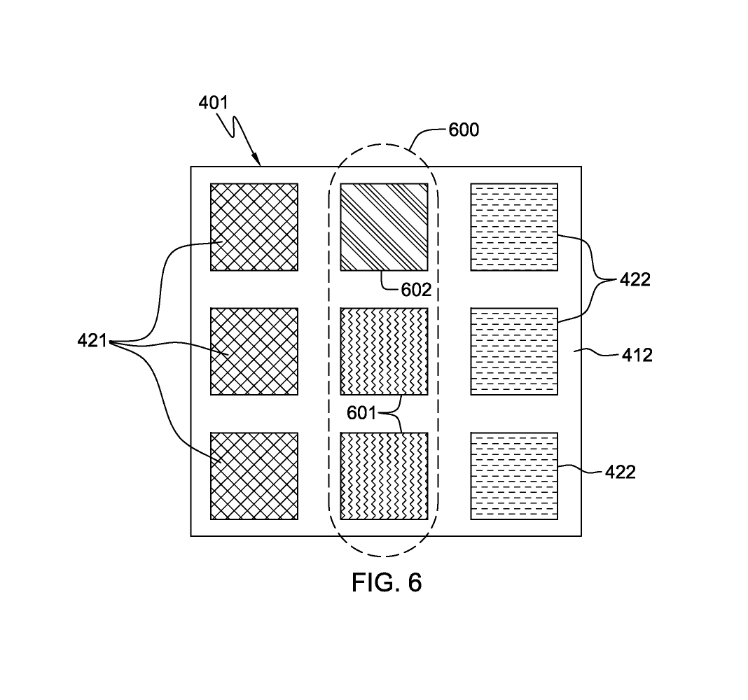

FIG. 6 depicts one sample array of light-emitting diodes and sensors coupled to (for instance, supported by, affixed to, built upon, etc.) acoustic coupler substrate 412 of the acoustic wave generator of cleaning tool 401. By way of example only, 3 first light-emitting diodes 421 and 3 second light-emitting diodes 422 are arrayed on opposite sides of acoustic coupler substrate 412. In one embodiment, cleaning tool 401 may be designed to move relative to surface 406 (see FIGS. 4 & 5) to be cleaned, for instance, by passing across or rotating relative to the surface. Note that any commercially available light-emitting diodes appropriate for use in a cleaning tool such as described herein may be integrated into the cleaning tool, that is, physically coupled, secured, built upon, etc., the acoustic coupler substrate of the acoustic wave generator. Note also that, although illustrated as a single acoustic wave generator in FIGS. 4-6, the cleaning tool may comprise multiple acoustic wave generators, each with one or more light-emitting diodes affixed or arrayed to, for instance, the surface of the acoustic coupler substrate facing the surface to be cleaned.

In the example of FIG. 6, multiple sensors 600 are also coupled to acoustic coupler substrate 412. In one embodiment, sensors 600 may include one or more radical sensors 601 and one or more hydrophone sensors or devices 602. As with the light-emitting diodes, sensors 601, 602 may be supported by or physically coupled to, for instance, secured to or built upon, the acoustic coupler substrate 412. By way of specific example, radical sensors 601 may comprise AlGaN-GaN high-electron mobility transistors (HEMTs), which are widely used as sensors for polar liquids, H₂ gas and pressure. Such devices or sensors could also be employed for radical detection such as disclosed herein during the cleaning process; that is, for detection or radicals such as H*, OH*, O*, CO*, O₃*, etc., in cleaning solution disposed between the cleaning tool and the surface from which particles are to be removed. The hydrophone sensor(s) or device(s) 602 may be provided to facilitate measuring acoustic pressure directed at the surface to be cleaned of particles.

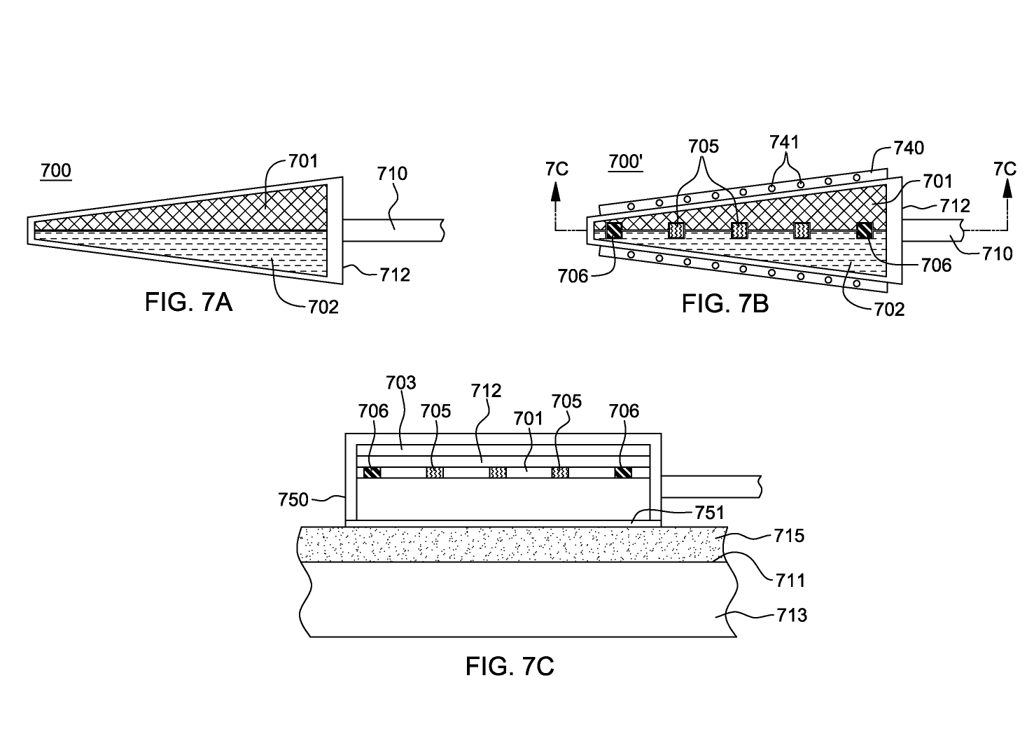

FIGS. 7A-7C depict further embodiments of an opto-acoustic apparatus such as disclosed herein. In FIG. 7A, one example of the underside of the cleaning tool 700 is depicted, that is, the side of the cleaning to be placed or held by support arm 710 in opposing relation to the surface to be cleaned. In this embodiment, cleaning tool 700, includes, for instance, an acoustic coupler substrate 712 of an acoustic wave generator (also comprising one or more acoustic transducers (not shown)) and one or more light sources 701, 702, such as light-emitting diodes. In the example shown, each of these structures is approximately triangular or pie-slice-shaped, or more simply, pie-shaped in plan view (as illustrated). This configuration advantageously facilitates a uniform exposure of the cleaning tool to a circular surface, such as a circular wafer surface to be cleaned, as the cleaning tool or surface rotates, in one implementation, with the tool and surface in opposing relation.

In FIG. 7B, an enhanced embodiment is depicted where the cleaning tool 700′ includes a support arm 710 coupled to, for instance, an acoustic coupler substrate 712 of an acoustic wave generator (which also comprises an acoustic transducer 703 (see FIG. 7C)) or, for instance, to a frame (not shown) coupled to the acoustic wave generator. In addition to having the pie-shaped configuration of the embodiment of FIG. 7A, cleaning tool 700′ of FIG. 7B includes multiple sensors, such as multiple radical sensors 705 and one or more hydrophone sensors or devices 706. In this embodiment, sensors 705, 706 are disposed along or aligned over the interface between the adjacent light sources 701, 702. Additionally, one or more manifolds 740 may be coupled to cleaning tool 700′, for instance, to be disposed adjacent to the side edges of acoustic coupler substrate 712. These one or more manifolds 740 may include a plurality of openings 741 for providing, for instance, chemicals into the cleaning solution, or the cleaning solution itself to the volume between the cleaning tool and the surface to be cleaned, as the surface or cleaning tool more or rotate relative to each other.

FIG. 7C depicts a side elevational view of one embodiment of the cleaning tool 700′ of FIG. 7B, operatively positioned over a surface 711 of a substrate, mask, etc., 713, to be cleaned. In one specific implementation, the first light source 701 may be a first light-emitting diode of a first wavelength, and the second light source 702 may be a second light-emitting diode of a second wavelength. For instance, the first wavelength and second wavelength may be 266 nm and 254 nm, as specific examples. As in the above examples, a protection layer, or a cover 750 with a protection window 751, such as a transparent window, may be provided to protect the light-emitting diodes from the cleaning solution 715.

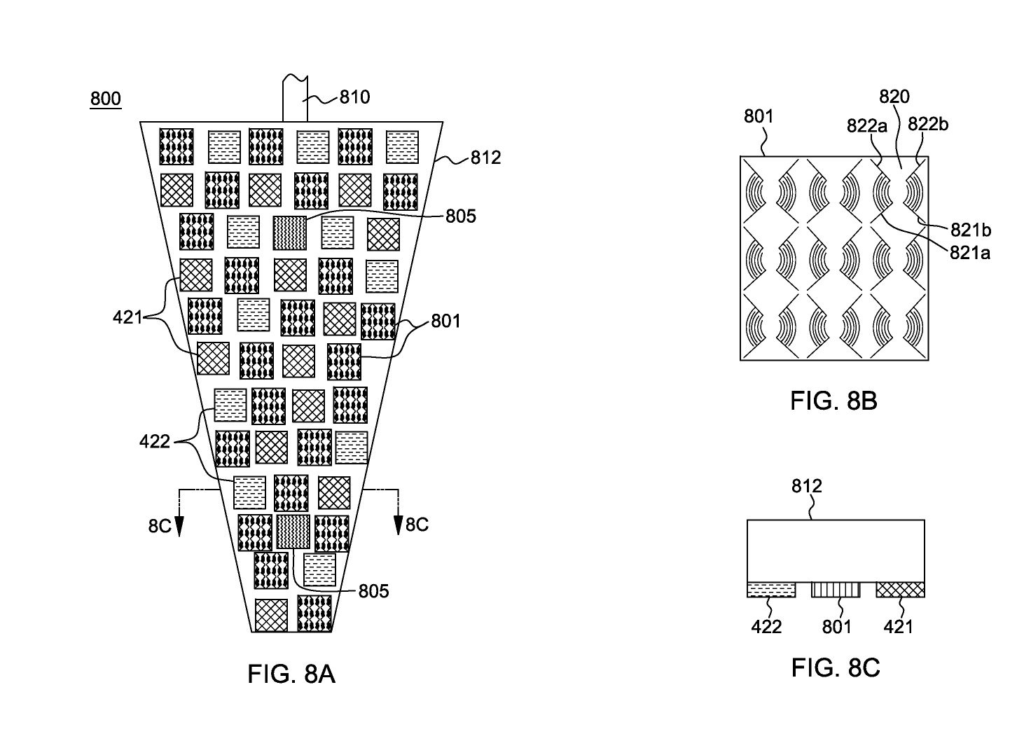

FIGS. 8A-8C depict another embodiment of an opto-acoustic apparatus such as disclosed herein.

In FIG. 8A, one example of the underside of a cleaning tool 800 is depicted, that is, the side of the cleaning tool to be placed or held by support arm 810 in opposing relation to the surface to be cleaned. In this embodiment, cleaning tool 800 includes, for instance, a mounting substrate 812, such as an aluminum or stainless steel surface, upon which one or more light sources 421, 422, such as light-emitting diodes (LEDs), are mounted, along with multiple surface acoustic wave generators 801, each of which may comprise, in one example, a surface acoustic wave (SAW) generator module, one embodiment of which is depicted in FIG. 8B.

In the embodiment of FIG. 8B, the surface acoustic wave generator module 801 may be built separately and then mounted to mounting substrate 812 (see FIG. 8A). By way of example, surface acoustic wave generator module 801 may include a piezoelectric substrate 820 and multiple interdigitated pairs of opposing conductor subassemblies 821A, 822A, and 821B, 822B, to which a high-frequency electrical voltage is applied, and from which an acoustic wave may propagate at the surface. When coupled via a liquid interface, the surface acoustic waves will propagate at an angle toward the surface to be cleaned. Note that both the surface acoustic wave generator modules 801 and the light sources 421, 422, may be built separately, and mounted to the mounting substrate 812. Further, one or more hydrophones or other sensors 805 may be provided.

In the example of FIG. 8A, the opto-acoustic cleaning tool is again pie-shaped in plan view to advantageously facilitate a uniform exposure of the cleaning tool to a circular surface, such as a circular wafer to be cleaned, as the cleaning tool or surface rotates, in one implementation, with the tool and surface in opposing relation.

In this regard, and by way of example only, reference U.S. Letters Patent No. 6,791,242 B2.

Note that in the embodiment presented, sensors 805 may comprise one or more hydrophone sensors or devices, as well as one or more radical sensors. As explained above, the first and second light sources 421, 422 may be of different wavelengths, and may comprise (by way of example) first and second light-emitting diodes of different wavelengths. Depending on the desired implementation, wavelengths in the range of 100-1,000 nanometers may be used.

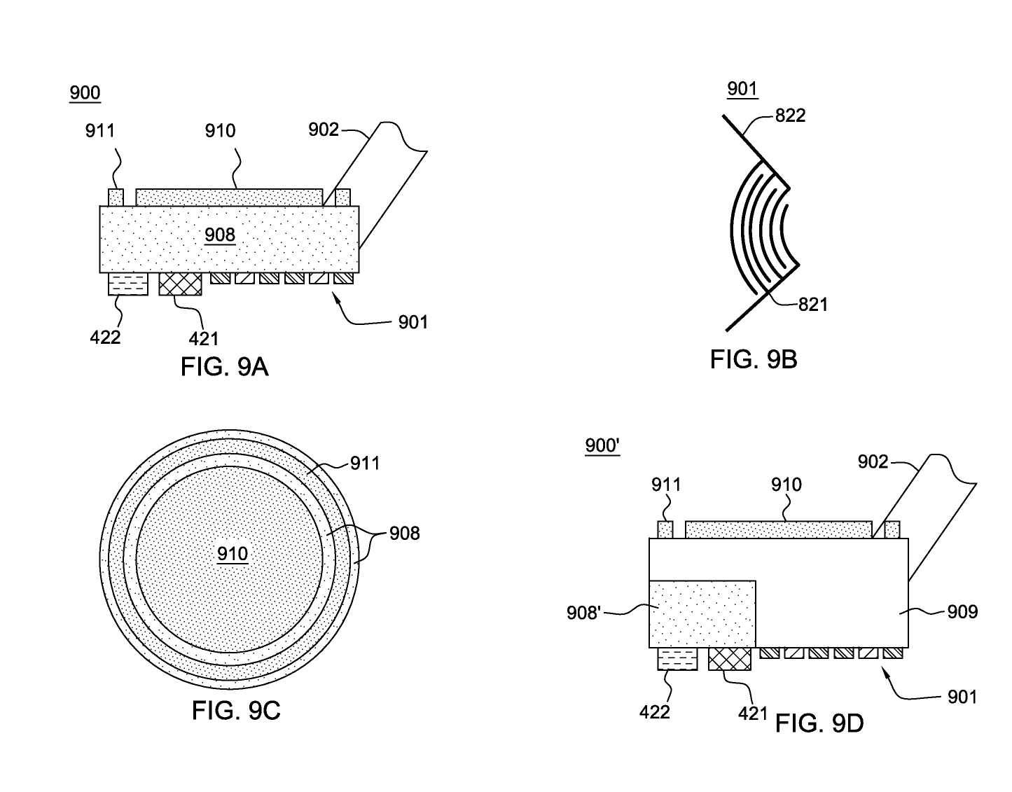

FIGS. 9A-9C depict another embodiment of an opto-acoustic cleaning apparatus, such as disclosed herein. In FIG. 9A, the cleaning tool is shown supported by a support arm or positioning regulator 901. In this example, multiple light sources 421, 422, and acoustic wave generators 902, may be provided on the underside of the cleaning tool 900, that is, the side of the cleaning tool to be placed or held by support arm 902 in opposing relation to the surface to be cleaned. In this embodiment, the supporting substrate having the mounting surface is an acoustic coupler, such as an aluminum nitride coupler, upon which the surface acoustic wave electrodes 821, 822 (FIG. 8B) may be arrayed in opposing sets, as in the example described above in connection with FIG. 8B. Electrodes 910, 911, may be disposed as illustrated in FIG. 9C, on the opposite main surface of acoustic coupler 908, and drive the surface acoustic wave generator 901.

FIG. 9D depicts an alternate cleaning tool embodiment, wherein the supporting substrate includes an acoustic coupler 908′, to which the light sources are mounted, and a piezoelectric transducer 909, to which the surface acoustic wave electrodes are mounted. In this alternate integration scheme, the piezoelectric transducer material 909 could be, for instance, coated over the acoustic coupler 908′, which in one embodiment, may comprise sapphire. Alternatively, the piezoelectric transducer material could be formed, then etched to allow the acoustic coupler to be attached to the piezoelectric transducer material to achieve a structure such as depicted in FIG. 9D.

Note that the specific embodiments of the cleaning tools of FIGS. 4-9D are presented by way of example only. Other configurations are also possible without departing from the scope of the claims presented herewith. In addition, the number and wavelengths of the light sources may vary, with the light-emitting diodes of different wavelengths being presented herein by way of example only. Further, the number and placement of radical sensors and hydrophone sensors may vary, depending on the desired tool implementation and operational feedback.

Note that in certain of the embodiments depicted, the light sources (e.g., light-emitting diodes) are disposed between the acoustic wave generator and the surface to be cleaned. As such, the generated acoustic waves and light overlap, at least partially, when the cleaning tool is disposed over the surface of interest, that is, the target surface from which particles are to be removed using the cleaning tool and apparatus disclosed herein. In certain embodiments, the acoustic waves propagate through the light-emitting diodes. Based on these teachings, one of ordinary skill in the art can readily implement a cleaning tool as disclosed herein with the materials of the light sources, acoustic transducers, and acoustic coupler substrates being chosen to accomplish the desired cleaning operation using both acoustic waves and light.

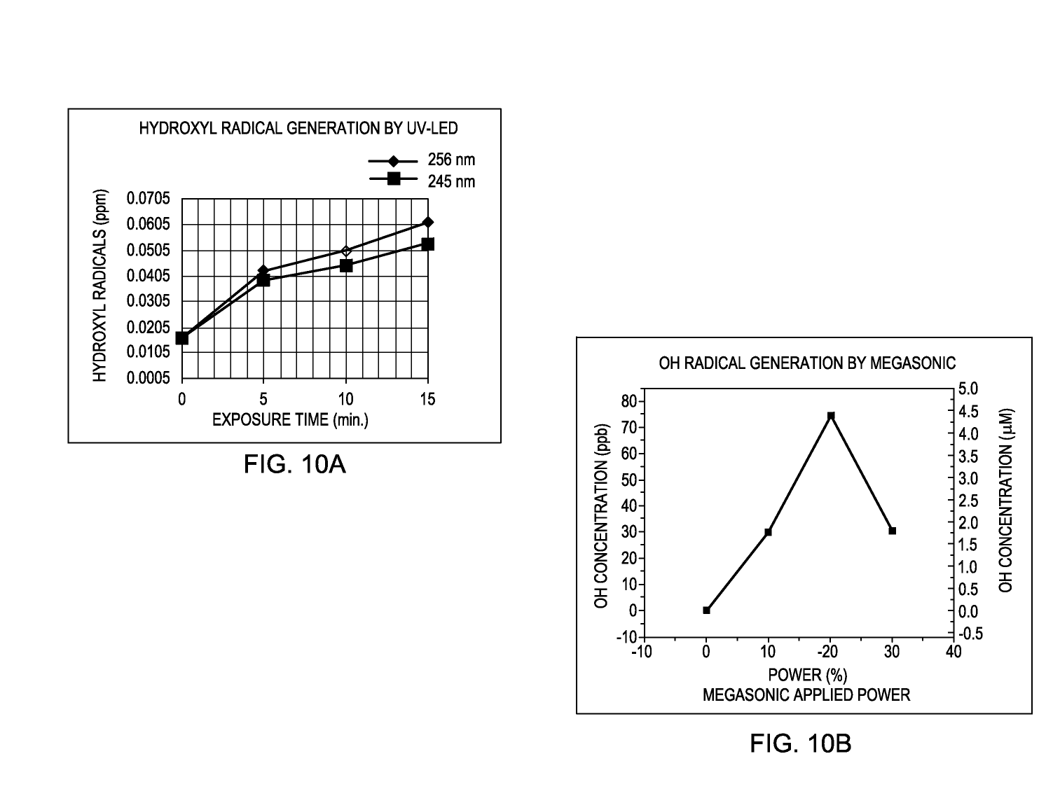

By way of further explanation, FIG. 10A is a graph of hydroxyl-radicals obtained versus relative exposure time, using an ultraviolet light-emitting diode-based cleaning tool, and certain chemistries, such as those discussed above. Note that the radical generation can be controlled by multiple parameters of the cleaning process. In FIG. 10B, hydroxyl-radical generation is plotted using acoustic waves in the megasonic range as a percentage of power applied to the acoustic transducer. As in the case of the ultraviolet light-emitting diodes, the acoustic transducer with megasonically-applied power also generates hydroxyl-radicals in the cleaning solution, which as noted above, further facilitates removal of particles from the surface to be cleaned.

As will be appreciated by one skilled in the art, one or more cleaning control aspects of the present invention may be embodied as a system, method or computer program product. Accordingly, one or more control aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, one or more control aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

In one example, a computer program product includes, for instance, one or more non-transitory computer readable storage media to store computer readable program code means or logic thereon to provide and facilitate one or more aspects of the present invention.

Program code embodied on a computer readable medium may be transmitted using an appropriate medium, including but not limited to, wireless, wireline, optical fiber cable, RF, etc., or any suitable combination of the foregoing.

Computer program code for carrying out operations for one or more aspects of the present invention may be written in any combination of one or more programming languages, including an object oriented programming language, such as Java, Smalltalk, C++ or the like, and conventional procedural programming languages, such as the “C” programming language, assembler or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

One or more control aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of one or more control aspects of the present invention. In this regard, each block in the flowchart or blocks diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In one aspect of the present invention, an application may be deployed for performing one or more control aspects of the present invention. As one example, the deploying of an application comprises providing computer infrastructure operable to perform one or more control aspects of the present invention.

As a further aspect of the present invention, a computing infrastructure may be deployed comprising integrating computer readable code into a computing system, in which the code in combination with the computing system is capable of performing one or more aspects of the present invention.

As yet a further aspect of the present invention, a process for integrating computing infrastructure comprising integrating computer readable code into a computer system may be provided. The computer system comprises a computer readable medium, in which the computer medium comprises one or more aspects of the present invention. The code in combination with the computer system is capable of performing one or more control aspects of the present invention.

Although various embodiments are described above, these are only examples. Further, other types of computing environments can benefit from one or more aspects of the present invention.

As a further example, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. An apparatus comprising:
a cleaning tool for facilitating removal of particles from a surface, the cleaning tool comprising:
at least one acoustic wave generator to direct acoustic waves towards the surface to be cleaned, the at least one acoustic wave generator comprising an acoustic transducer which facilitates generating the acoustic waves, and an acoustic coupler substrate through which the acoustic waves propagate; and
at least one light source to direct light towards the surface to be cleaned, the at least one light source being coupled to the acoustic coupler substrate of the at least one acoustic wave generator, and the at least one acoustic wave generator and the at least one light source being spaced from the surface to be cleaned, and are configured to selectively concurrently direct overlapping, at least partially, acoustic waves and light towards the surface to facilitate removal of particles from the surface.

2. The apparatus of claim 1, wherein the at least one light source is located between the acoustic coupler substrate and the surface to be cleaned.

3. The apparatus of claim 2, wherein the acoustic waves propagate, in part, through the at least one light source towards the surface to be cleaned.

4. The apparatus of claim 1, wherein the at least one light source of the cleaning tool comprises a plurality of light sources coupled to the acoustic coupler substrate of the acoustic wave generator at a first side of the acoustic coupler substrate facing the surface to be cleaned, and wherein the acoustic transducer is coupled to a second side of the acoustic coupler substrate, the first side and the second side being opposing sides of the acoustic coupler substrate.

5. The apparatus of claim 1, wherein the at least one light source of the cleaning tool comprises a plurality of light-emitting diodes affixed to the acoustic coupler substrate of the at least one acoustic wave generator for directing the light towards the surface to be cleaned.

6. The apparatus of claim 5, wherein the plurality of light-emitting diodes comprise a first light-emitting diode emitting light of a first wavelength, and a second light-emitting diode emitting light of a second wavelength, wherein the first wavelength and the second wavelength are different wavelengths in the range of 140 to 1,000 nanometers.

7. The apparatus of claim 5, further comprising a protective transparent layer surrounding, at least partially, the plurality of light-emitting diodes.

8. The apparatus of claim 5, wherein the acoustic coupler substrate comprises an acoustic wave coupling material, and wherein the protective transparent layer also comprises the acoustic wave coupling material.

9. The apparatus of claim 5, wherein the acoustic coupling material comprises sapphire.

10. The apparatus of claim 1, wherein the cleaning tool further comprises:
a liquid source configured to provide a cleaning liquid between the surface to be cleaned, and the at least one acoustic wave generator and at least one light source, substantially concurrent with the directing of acoustic waves and light towards the surface to be cleaned; and
at least one radical sensor coupled to the acoustic coupler substrate of at least one acoustic wave generator, the at least one radical sensor sensing active radicals in the cleaning liquid between the surface to be cleaned and the at last one acoustic wave generator and at least one light source.

11. The apparatus of claim 10, further comprising at least one hydrophone device coupled to the acoustic coupler substrate of the at least one acoustic wave generator, the at least one hydrophone device facilitating measuring, at least in part, acoustic pressure directed at the surface to be cleaned.

12. The apparatus of claim 1, wherein at least one of the cleaning tool or the surface to be cleaned rotates relative to the other, and a surface of the acoustic coupler substrate opposing the surface to be cleaned is approximately pie-shaped in plan view.

13. The apparatus of claim 12, wherein the at least one light source of the cleaning tool comprises multiple light-emitting diodes, the multiple light-emitting diodes comprising a first light-emitting diode emitting light of a first wavelength, and a second light-emitting diode emitting light of a second wavelength, the first wavelength and the second wavelengths being different wavelengths, and wherein the first light-emitting diode and the second light-emitting diode are each approximately pie-shaped in plan view and coupled to the approximately pie-shaped surface of the acoustic coupler substrate of the at last one acoustic wave generator.

14. The apparatus of claim 13, wherein the cleaning tool further comprises a liquid source to provide a cleaning liquid between the surface to be cleaned, and the at least one acoustic wave generator and plurality of light-emitting diodes, substantially concurrent with the directing of acoustic waves and light towards the surface of to be cleaned, and wherein the cleaning tool further comprises at least one sensor coupled to the acoustic coupler substrate of the at least one acoustic wave generator, the at least one sensor comprising at least one of a radical sensor or a hydrophone device.

15. The apparatus of claim 12, wherein the cleaning tool further comprises liquid manifolds disposed adjacent to the acoustic coupler substrate of the at least one acoustic wave generator and facilitating introduction of at least one of a cleaning chemical or the cleaning liquid between the surface to be cleaned and the at least one acoustic wave generator and at least one light source.

16. The apparatus of claim 1, wherein the surface is a surface of one or more monolayers of film.

17. The apparatus of claim 1, wherein the acoustic transducer comprises at least one surface acoustic wave generator.

18. An apparatus comprising:
a cleaning tool for facilitating removal of particles from a surface, the cleaning tool comprising:
an acoustic wave generator to direct acoustic waves towards the surface to be cleaned, the acoustic wave generator comprising an acoustic transducer which facilitates generating the acoustic waves, and an acoustic coupler substrate through which the acoustic waves propagate; and
a plurality of light-emitting diodes to direct light towards the surface to be cleaned, the plurality of light-emitting diodes being coupled to the acoustic coupler substrate and disposed between the acoustic coupler substrate of the acoustic wave generator and the surface to be cleaned, the acoustic wave generator and the plurality of light-emitting diodes being spaced from the surface to be cleaned, and are configured to selectively concurrently direct overlapping, at least in part, acoustic waves and light towards the surface to facilitate removal of particles from the surface.

19. The apparatus of claim 18, wherein the acoustic waves propagate, in part, through the plurality of light-emitting diodes towards the surface to be cleaned.

20. The apparatus of claim 18, wherein the plurality of light-emitting diodes comprise a first light-emitting diode emitting light of a first wavelength and a second light-emitting diode emitting light of a second wavelength, the first wavelength and the second wavelengths being different wavelengths.

21. The apparatus of claim 18, wherein the cleaning tool further comprises:
a liquid source configured to provide a cleaning liquid between the surface to be cleaned, and the acoustic wave generator and plurality of light-emitting diodes, substantially concurrent with the directing of acoustic waves and light towards the surface to be cleaned; and
at least one sensor supported by the acoustic coupler substrate of the acoustic wave generator, the at least one sensor comprising at least one of a radical sensor or a hydrophone device, the radical sensor sensing presence of active radicals in the cleaning liquid, and the hydrophone device facilitating measuring acoustic pressure directed towards the surface to be cleaned.

22. The apparatus of claim 21, wherein at least one of the cleaning tool or the surface rotates relative to the other, and wherein a surface of the acoustic coupler substrate of the acoustic wave generator opposing the surface to be cleaned is approximately pie-shaped in plan view, increasing in width outwards.

23. A method comprising:
providing a cleaning tool for facilitating removal of particles from a surface, the providing comprising:
providing at least one acoustic wave generator to direct acoustic waves towards the surface to be cleaned, the acoustic wave generator comprising an acoustic transducer which facilitates generating the acoustic waves, and an acoustic coupler substrate through which the acoustic waves propagate; and
providing at least one light source to direct light towards the surface to be cleaned, the at least one light source being coupled to the acoustic coupler substrate of the at least one acoustic wave generator, and the at least one acoustic wave generator and at least one light source being spaced from the surface to be cleaned, and being configured to selectively concurrently direct overlapping, at least partially, acoustic waves and light towards the surface to facilitate removal of particles from the surface.
